(19) United States
(12) Patent Application Publication
(10) Pub. No.: US 2025/0095010 A1
(43) Pub. Date: Mar. 20, 2025

(54) SYSTEM AND METHOD FOR ESTIMATING IMPACT OF CUSTOMER SENTIMENT ON NET PROMOTER SCORE

(71) Applicant: DRSYA TECHNOLOGIES PRIVATE LIMITED, Bangalore (IN)

(72) Inventors: ASHISH MUNGI, Bangalore (IN); AJIT RAO, Bangalore (IN); SESHAGIRI GUDIPUDI, Bangalore (IN)

(73) Assignee: DRSYA TECHNOLOGIES PRIVATE LIMITED, Bangalore (IN)

(21) Appl. No.: 18/813,097

(22) Filed: Aug. 23, 2024

Related U.S. Application Data
(60) Provisional application No. 63/578,166, filed on Aug. 23, 2023.

(51) Int. Cl. G06Q 30/0203

(52) U.S. Cl. CPC G06Q 30/0203

(57) ABSTRACT

The present invention relates to a system (100) for determining actionable brand equity, comprise of a data acquisition module (127) and a data processing module (128) integrated with a brand presence assessment module (1281), a brand experience assessment module (1282), a brand edge assessment module (1283), and a brand preference assessment module (1284). The brand presence assessment module (1281) captures top-of-mind awareness responses, the brand experience assessment module (1282) utilizes net promoter scores to rank brands based on respondent experiences, the brand edge assessment module assesses brand differentiators, while the brand preference assessment module (1283), gauges brand likability. Each of the modules generate a module-level score and grade to be used by a concerned authority to produce a set of actions for improving brand presence, brand experience, brand edge and brand presence. A composite grading module combines presence, experience, edge, and preference scores to offer an actionable brand equity grade.

### FIELD OF THE INVENTION

Embodiments of the invention relate generally to data analysis system and method. More specifically, embodiments of the invention provide a system and method for estimating influencing metrics and impact of customer sentiment on net promoter score.

### DESCRIPTION OF THE RELATED ART

Net Promoter Score (NPS) is a metric used to measure customer loyalty and satisfaction. NPS is commonly used by businesses to assess how likely customers are to recommend their products or services to others. The NPS system categorizes customers into three groups based on their response to a simple rating question: “On a scale of 0-10, how likely are you to recommend our company/product/service to a friend or colleague?” Customers who give a score of 9 or 10 are considered promoters, those who give a score of 7 or 8 are considered passive, and those who give a score of 6 or below are considered detractors. Promoters are highly satisfied and loyal customers who are more likely to actively promote the brand and company. Passives are somewhat satisfied but less likely to actively promote the brand or company. Detractors are dissatisfied and may even discourage others from using the company's products or services.

NPS provides a single score that enables tracking and comparison of customer loyalty over time. The net promoter score is calculated by subtracting the percentage of detractors from the percentage of promoters and is generally quoted as an integer rather than as a percentage. The score can range from −100 (if everyone is a detractor) to +100 (if everyone is a promoter). A high net promoter score is generally considered a good indicator of customer loyalty and satisfaction.

The main NPS rating question is generally accompanied by an additional open-ended question “Please tell us why” or “Please tell us the reason for your rating” or similar variations. The open-ended question “Please tell us why” allows the respondent to enter a free text response to express their thoughts, inputs, opinions, feedback or whatever else they may feel like writing to substantiate why they gave the score or rating that they did in the first question of the NPS survey.

Based on the free-text responses, we may encounter the following 4 scenarios:

1) It is possible that a customer gives a rating of 9 or 10 (Promoter) because that customer may have low expectations from the company, and the customer's experience of the company's products or services has clearly exceeded their expectations. However, in their responses, the customer may have expressed certain negative comments or negative sentiments.

2) Similarly, a customer giving a rating of 0-6 (Detractor) could be because the customer's expectations are high, and their experience of the company's products or services did not meet their high expectations. However, in their responses, the customer may have expressed general satisfaction with the company's product or services.

3) Each customer has his/her own understanding of the rating scale i.e. a rating is individual driven. For example, it is possible that a rating of 7 for one customer could be a 9 or a 6 for another customer and hence a rating by a customer cannot be easily normalized purely based on the rating alone.

4) A customer who rates a 9 or 10 (considered a Promoter) may express negative sentiments in their free-text response, whereas a customer who rates 7 (considered a Passive) may have very favorable sentiments as expressed in their free-text responses. Similarly, someone who rates a 5 or 6 (Detractor) may be neutral, indifferent and not negative in their responses.

Typically, in NPS survey results, the individual free-text responses are simply appended as a set of text responses for reading and reference. They may be analyzed manually or using tools, but there is no specific analysis requirement mandated by the standard NPS methodology for the open-ended question.

To gain a more comprehensive understanding of customer feedback from the NPS survey, organizations may need to consider analyzing and incorporating the insights from the qualitative responses provided by customers to help drive meaningful improvements in products, services, and customer experiences.

Sentiment analysis (or opinion mining) is a natural language processing (NLP) technique used to determine whether data is positive, negative, or neutral. Sentiment analysis is often performed on textual data to help businesses monitor brand and product sentiment in customer feedback and understand customer needs.

Sentiments can be categorized into multiple scales, such as “Positive, Neutral, Negative”, “Clearly Positive, Positive, Mixed, Neutral, Negative, Clearly Negative” or variations of such scales. The wording of the scale may differ based on the granularity expressed by the sentiment scale. Sentiment scales may also be expressed numerically as scores, and the scores may be mapped to words, for example a score of 0.8 may mean Positive sentiment, a score of 0 may mean Neutral Sentiment, and a score of −0.2 may mean Negative sentiment.

It is important to note that the standard NPS methodology does not analyze the free-text responses or take into account the sentiments expressed in the free-text responses of the survey respondents. This limitation means that a significant amount of valuable data and information gathered from the NPS survey may be overlooked or unused.

Further, estimation of influencing metrics and the impact of customer sentiment on the Net Promoter Score (NPS) may provide valuable insights and enhance the understanding of customer loyalty and satisfaction.

Firstly, organizations may get an enhanced understanding of customer loyalty and satisfaction by analyzing customer sentiment alongside NPS scores. This comprehensive assessment may help identify the factors that drive customer satisfaction or dissatisfaction. Secondly, such estimation allows organizations to pinpoint specific areas for improvement. By identifying the influencing metrics and understanding the impact of customer sentiment on NPS, organizations can prioritize and target improvements to address the identified issues. The targeted approach leads to more effective enhancements in products, services, and overall customer experiences.

Furthermore, incorporating customer sentiment analysis into NPS calculations provides actionable insights. By considering qualitative feedback and sentiments expressed by customers, organizations extract valuable information and identify specific actions or changes that can positively impact the NPS, which enables more focused and effective decision-making regarding customer-centric initiatives.

Moreover, estimating the impact of customer sentiment on NPS enables organizations to proactively address potential issues. By monitoring customer sentiment, organizations detect early warning signs and resolve concerns before they escalate into significant problems.

Currently, there is no standardized method or system for determining the influencing metrics and impact of customer sentiment on the Net Promoter Score (NPS).

Therefore, due to the aforementioned drawbacks there is a need for a system and method for estimating influencing metrics and impact of customer sentiment on net promoter score.

### SUMMARY

A system and method are disclosed for estimating influencing metrics and impact of customer sentiment on net promoter score.

In a preferred embodiment, the system for estimating influencing metrics and impact of customer sentiment on net promoter score is disclosed. The system comprise of one or more hardware processors, a memory coupled to the one or more hardware processors. The memory comprises a plurality of modules in the form of programmable instructions executable by the one or more hardware processors. The plurality of modules comprise of a data acquisition module for receiving a response to a net promoter score survey from a survey respondent, a data processing module for estimating one or more influencing metrics and impact of customer sentiment on said net promoter score. The data processing module is configured to calculate a respondent type of promoter, passive or detractor based on the rating provided by the respondent, classify the NPS rating into high, medium and low values, and analyze the sentiment of the free-text response given by the respondent to determine positive, negative or neutral sentiment. Further, the data processing module is configured to identify or define a metric which is to be estimated and generating a metric accordingly for each combination of the response sentiment and net promoter score rating, define a weight value for said combination of the response sentiment and the net promoter score rating, count and tabulate the response to the net promoter score survey for said combination of a response sentiment and a net promoter score rating, multiply said weight value with the response count for obtaining a weighted segment-wise count, calculate an aggregate weighted average for the said metric, interpret a value of said metric in a business context, calculate a true net promoter score with equal weightage to response sentiment and net promoter score rating, calculate a true net promoter score with higher weightage to response sentiment than net promoter score rating, calculate a true net promoter score with higher weightage to net promoter score rating than response sentiment, and interpret the true net promoter scores in a business context for estimating one or more influencing metrics and impact of customer sentiment on said net promoter score.

In a preferred embodiment, the computer-implemented method comprise steps of receiving a response to a net promoter score survey from a survey respondent, calculating a respondent type of promoter, passive or detractor based on the rating provided by the respondent, classifying the NPS rating into high, medium and low values, analyzing the sentiment of the free-text response given by the respondent to determine positive, negative or neutral sentiment, identifying or defining a metric which is to be estimated and generating a metric accordingly for each combination of a response sentiment and a net promoter score rating, defining a weight value for said combination of a response sentiment and a net promoter score rating, counting and tabulating the response to the net promoter score survey for said combination of a response sentiment and a net promoter score rating, multiplying said weight value with the response count for obtaining a weighted segment-wise count, calculating an aggregate weighted average for the said metric, interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

In a preferred embodiment, the present invention provides a non-transitory computer-readable storage medium for storing one or more instructions for estimating influencing metrics and impact of customer sentiment on net promoter score. The storage medium comprising an executable code which when executed by one or more units of a system causes a processor to receive a response to a net promoter score survey from a survey respondent. The processor is further configured to calculate a respondent type of promoter, passive or detractor based on the rating provided by the respondent, classifying the net promoter score rating into high, medium and low values, analyzing the sentiment of the free-text response given by the respondent to determine positive, negative or neutral sentiment. The processor is further configured to identify or defining a metric which is to be estimated and generating a metric accordingly for each combination of a response sentiment and a net promoter score rating. The processor is further configured to define a weight value for said combination of a response sentiment and a net promoter score rating. The processor is further configured to count and tabulating the response to the net promoter score survey for said combination of a response sentiment and a net promoter score rating. The processor is further configured to multiply said weight value with the response count for obtaining a weighted segment-wise count in a metric. The processor is further configured to calculate an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

In a preferred embodiment, the present invention provides a user device for estimating influencing metrics and impact of customer sentiment on net promoter score. The user device comprises a memory, a processor connected with the memory. The processor is configured to estimate influencing metrics and impact of customer sentiment on net promoter score equity via a system and the influencing metrics and impact of customer sentiment on net promoter score equity is estimated by receiving a response to a net promoter score survey from a survey respondent. The influencing metrics and impact of customer sentiment on net promoter score equity is further estimated by calculating a respondent type of promoter, passive or detractor based on the rating provided by the respondent, classifying the net promoter score rating into high, medium and low values, analyzing the sentiment of the free-text response given by the respondent to determine positive, negative or neutral sentiment and identifying or defining a metric which is to be estimated and generating a metric accordingly for each combination of a response sentiment and a net promoter score rating. The influencing metrics and impact of customer sentiment on net promoter score equity is further estimated by defining a weight value for said combination of a response sentiment and a net promoter score rating and counting and tabulating the response to the net promoter score survey for said combination of a response sentiment and a net promoter score rating. The influencing metrics and impact of customer sentiment on net promoter score equity is further estimated by multiplying said weight value with the response count for obtaining a weighted segment-wise count in a metric and calculating an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

### BRIEF DESCRIPTION OF THE DRAWING

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of illustrating internal and external components of an embodiment of a system in which embodiments described herein may be implemented in accordance with the present disclosure.

FIG. 2A and FIG. 2B depicts a flow diagram describing an embodiment of a method for estimating influencing metrics and impact of customer sentiment on net promoter score in accordance with the present disclosure.

FIG. 3 depicts a schematic diagram of a matrix for mapping the response sentiment to the net promoter score rating (or to the net promoter score respondent segments) to determine the true net promoter score respondent segments in which equal weightage is given to rating and response sentiment in accordance with the present disclosure.

FIG. 4 depicts a flow diagram for determining true NPS respondent segments and counts for true promoters, true passives, mixed passives and true detractors, with equal weightage given to rating and response sentiment in accordance with the present disclosure.

FIG. 5 depicts a schematic diagram of a matrix for mapping the response sentiment to the net promoter score rating (or to the net promoter score respondent segments) to determine the true net promoter score respondent segments in which higher weightage is given to response sentiment than to rating in accordance with the present disclosure.

FIG. 6 depicts a flow diagram for determining true NPS respondent segments and counts for true promoters, true passives, mixed passives and true detractors, with higher weightage given to response sentiment than to rating in accordance with the present disclosure.

FIG. 7 depicts a schematic diagram of a matrix for mapping the response sentiment to the net promoter score rating (or to the net promoter score respondent segments) to determine the true net promoter score respondent segments in which higher weightage is given to rating than to response sentiment in accordance with the present disclosure.

FIG. 8 depicts a flow diagram for determining true NPS respondent segments and counts for true promoters, true passives, mixed passives and true detractors, with higher weightage given to rating than to response sentiment in accordance with the present disclosure.

FIG. 9A and FIG. 9B depicts another flow diagram describing an embodiment of a method for estimating influencing metrics and impact of customer sentiment on net promoter score in accordance with the present disclosure.

FIG. 10 depicts a schematic diagram of a matrix for mapping the response sentiment to the net promoter score rating (or to the net promoter score respondent segments) for a defined metric in accordance with the present disclosure.

FIG. 11 depicts a schematic diagram of a matrix for mapping the response sentiment to the net promoter score rating (or to the net promoter score respondent segments) for a defined metric with unknown response sentiment, as a variation of FIG. 10, in accordance with the present disclosure.

FIG. 12 depicts a schematic diagram of a matrix for mapping the response sentiment to the net promoter score rating (or to the net promoter score respondent segments) for segment-wise weights for a defined metric in accordance with the present disclosure.

FIG. 13 depicts a schematic diagram of a matrix for mapping the response sentiment to the net promoter score rating (or to the net promoter score respondent segments) for segment-wise count of responses for a defined metric in accordance with the present disclosure.

FIG. 14 depicts a schematic diagram of a matrix for mapping the response sentiment to the net promoter score rating (or to the net promoter score respondent segments) for weighted segment-wise counts for a defined metric in accordance with the present disclosure.

FIG. 15 depicts a schematic diagram of an example business metric “Probability of customer churn” with a matrix containing values in each cell with color coded words or phrases depicting, for each combination of Response Sentiment and NPS Rating, what the combination means in the context of the business metric, in accordance with the present disclosure.

FIG. 16 depicts a schematic diagram of a business metric “probability of customer churn” with sample segment-wise weights in accordance with the present disclosure.

FIG. 17 depicts a schematic diagram of a business metric “probability of customer churn” with sample segment-wise count of responses in accordance with the present disclosure.

FIG. 18 depicts a schematic diagram of a business metric “probability of customer churn” with sample weighted segment-wise counts in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a system for estimating influencing metrics and impact of customer sentiment on net promoter score, comprising of, one or more hardware processors, a memory coupled to the one or more hardware processors. The memory comprises a plurality of modules in the form of programmable instructions executable by the one or more hardware processors. The plurality of modules comprise of a data acquisition module for receiving a response to a net promoter score survey from a survey respondent, a data processing module for estimating one or more influencing metrics and impact of customer sentiment on said net promoter score. The data processing module is configured to calculate a respondent type of promoter, passive or detractor based on the rating provided by the respondent, classify the NPS rating into high, medium and low values, and analyze the sentiment of the free-text response given by the respondent to determine positive, negative or neutral sentiment. Further, the data processing module is configured to identify or define a metric which is to be estimated and generating a metric accordingly for each combination of the response sentiment and net promoter score rating, define a weight value for said combination of the response sentiment and the net promoter score rating, count and tabulate the response to the net promoter score survey for said combination of a response sentiment and a net promoter score rating, multiply said weight value with the response count for obtaining a weighted segment-wise count, calculate an aggregate weighted average for the said metric, interpret a value of said metric in a business context, calculate a true net promoter score with equal weightage to response sentiment and net promoter score rating, calculate a true net promoter score with higher weightage to response sentiment than net promoter score rating, calculate a true net promoter score with higher weightage to net promoter score rating than response sentiment, and interpret the true net promoter scores in a business context for estimating one or more influencing metrics and impact of customer sentiment on said net promoter score.

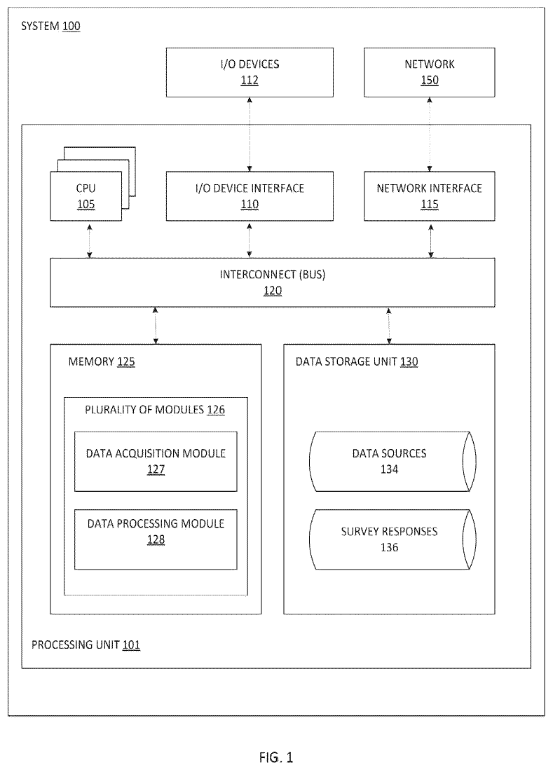

FIG. 1 depicts a block diagram of illustrating internal and external components of an embodiment of a system in which embodiments described herein may be implemented in accordance with the present disclosure. The system (100) comprises one or more processing units (101). Each processing unit (101) includes a memory (125), data storage (130), an interconnect (e.g., BUS) (120), one or more processors (e.g., CPUs) (105), an I/O device interface (110), I/O devices (112), and a network interface (115).

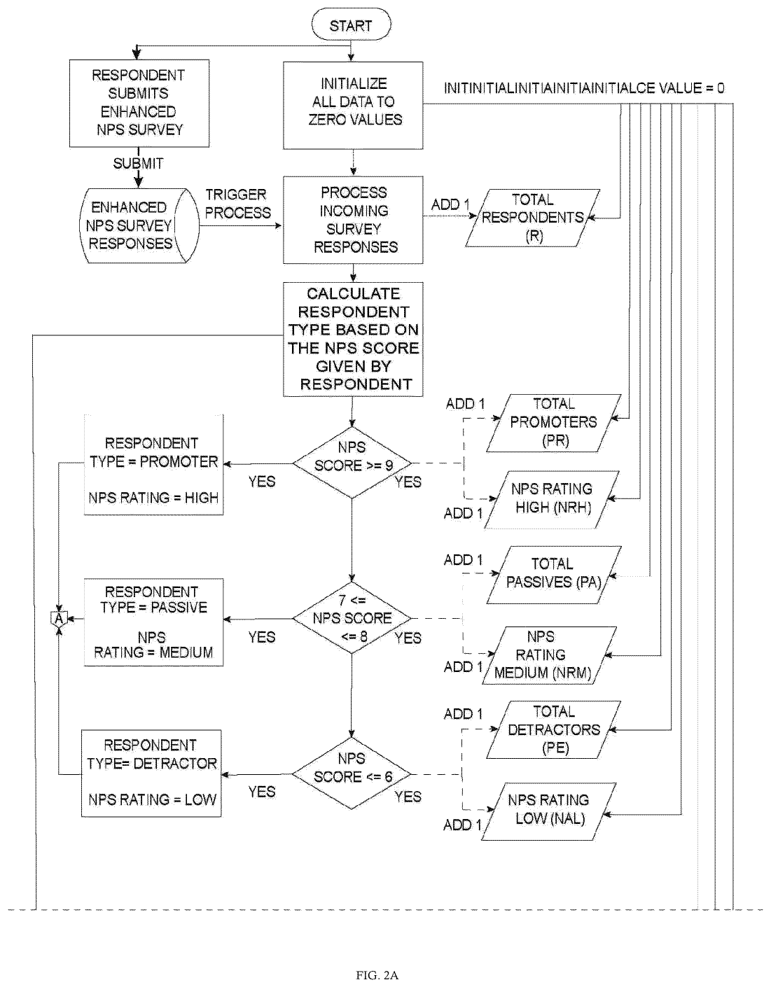

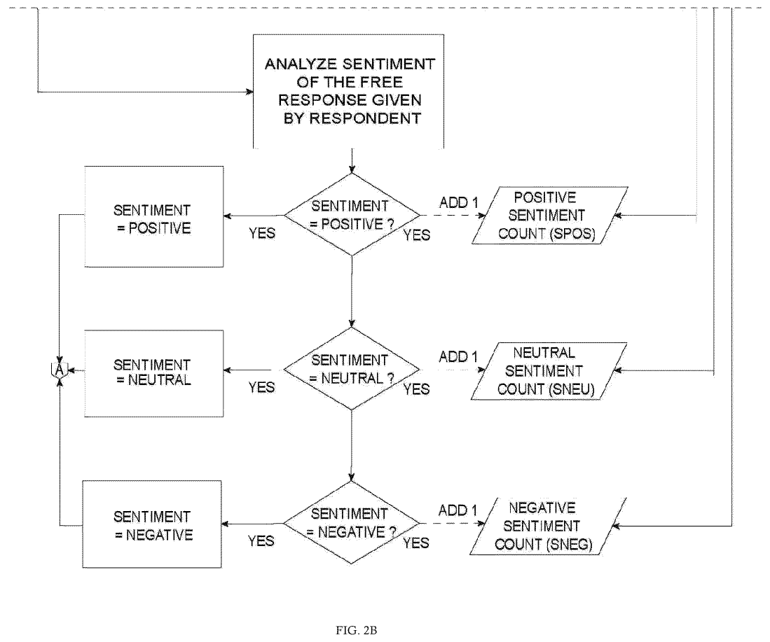

Each processor (105) can be communicatively coupled to the memory (125) or storage (130). Each processor (105) can retrieve and execute programming instructions stored in memory (125) or storage (130). In some embodiments, each processor (105) can execute methods as shown and described hereinafter with reference to FIG. 2A and FIG. 2B through FIG. 18, or equivalents thereof. The interconnect (120) is used to move data, such as programming instructions, between the CPU (105), I/O device interface (110), storage (130), network interface (115), and memory (125). The interconnect (bus) (120) can be implemented using one or more buses. The processors (105) can be a single CPU, multiple CPUs, or a single CPU having multiple processing cores in various embodiments. In some embodiments, a processor (105) can be a digital signal processor (DSP). Memory (125) is generally included to be representative of a random-access memory (e.g., static random-access memory (SRAM), dynamic random-access memory (DRAM), or Flash). The storage (130) is generally included to be representative of a non-volatile memory, such as a hard disk drive, solid state device (SSD), removable memory cards, optical storage, or flash memory devices. In an alternative embodiment, the storage (130) can be replaced by storage area-network (SAN) devices, the cloud, or other devices connected to the processing unit (101) via the I/O device interface (110) or a communication network (150) via the network interface (115).

The network (150) can be implemented by any number of any suitable communications media (e.g., wide area network (WAN), local area network (LAN), Internet, Intranet, etc.). In certain embodiments, the network (150) can be implemented within a cloud computing environment or using one or more cloud computing services. In some embodiments, the network interface (115) communicates with both physical and virtual networks.

The processing unit (101) and the I/O Devices (112) can be local to each other, and communicate via any appropriate local communication medium (e.g., local area network (LAN), hardwire, wireless link, Intranet, etc.) or they can be physically separated and communicate over a virtual network. In some embodiments, the I/O devices (112) can include a display unit capable of presenting information (e.g., a survey or a set of questions) to a user and receiving one or more inputs (e.g., a survey response or a set of answers) from a user.

In some embodiments, the memory (125) stores a plurality of modules (126) including a data acquisition module (127) and a data processing module (128) while the storage (130) stores data sources (134) and NPS survey responses (136). However, in various embodiments, the plurality of modules (126) including a data acquisition module (127) and a data processing module (128), the data sources (134), and the NPS survey responses (136) are stored partially in memory (125) and partially in storage (130), or they are stored entirely in memory (125) or entirely in storage (130), or they are accessed over a network (150) via the network interface (115).

The data acquisition module (127) and data processing module (128) can store processor executable instructions for various methods such as the methods shown and described hereinafter with respect to FIG. 2A and FIG. 2B through FIG. 18 or the equivalents thereof. In some embodiments, the data sources (134) can comprise documents containing tabular data such as, but not limited to, Portable Document Format (PDF), Word, Excel, PowerPoint, Open Document Format, Google Documents, or other document files. The data sources (134) can contain media such as video files, audio files, images and animations in various file formats such as, but not limited to, MP4, MOV, MP3, WAV, JPG, PNG, GIF, etc. The data sources (134) can further contain web content such as, but not limited to, hypertext markup language (HTML) web content, extensible markup language (XML) web content, or other web content. The NPS survey responses (136) can comprise both actual responses received through the surveys, computed data fields and data indices in various embodiments. In some cases, the NPS survey responses (136) are generated by one or more processors (105) evaluating one or more data sources (134) according to data processing module (128) instructions.

The memory (125) comprises a plurality of modules (126) in the form of programmable instructions executable by the one or more hardware processors (105). The plurality of modules (126) comprise a data acquisition module (127) and a data processing module (128). The data acquisition module (127) is configured to conduct a net promoter score survey and receive a response to a net promoter score survey from a survey respondent. The data processing module (128) is for estimating one or more influencing metrics and impact of customer sentiment on said net promoter score.

The data processing module (128) is configured to calculate a respondent type of promoter, passive or detractor based on the rating provided by the respondent, classify the NPS rating into high, medium and low values, and analyze the sentiment of the free-text response given by the respondent to determine positive, negative or neutral sentiment. Further, the data processing module (128) is configured to identify or define a metric which is to be estimated and generating a metric accordingly for each combination of the response sentiment and net promoter score rating, define a weight value for said combination of the response sentiment and the net promoter score rating, count and tabulate the response to the net promoter score survey for said combination of a response sentiment and a net promoter score rating, multiply said weight value with the response count for obtaining a weighted segment-wise count, calculate an aggregate weighted average for the said metric, interpret a value of said metric in a business context, calculate a true net promoter score with equal weightage to response sentiment and net promoter score rating, calculate a true net promoter score with higher weightage to response sentiment than net promoter score rating, calculate a true net promoter score with higher weightage to net promoter score rating than response sentiment, and interpret the true net promoter scores in a business context for estimating one or more influencing metrics and impact of customer sentiment on said net promoter score.

The response to the core net promoter score (NPS) question “On a scale from 0 to 10, how likely are you to recommend this product/service/company to a friend or colleague?” is a rating on a scale of 0-10 provided by the survey respondent. Based on the rating provided, the standard NPS methodology segments the respondents into Promoters (respondents who give rating 9 or 10), Passives (respondents who give rating 7 or 8) and Detractors (respondents who give rating 0 to 6).

The present invention segments the NPS ratings into 3 values: High (rating 9 or 10 corresponding to respondent segment Promoters), Medium (rating 7 or 8 corresponding to respondent segment Passives), Low (rating 0 through 6 corresponding to respondent segment Detractors). Each NPS survey response has a rating and a free-text response, which is analyzed for its sentiment.

The present invention defines a sentiment scale comprising of 3 sentiment values-Positive, Neutral and Negative. It is understood that in various embodiments, the sentiment scale may be defined with any other granularity or additional set of values such as Clearly Positive, Positive, Neutral, Mixed, Negative and Clearly Negative, or with numerical values such as 1, 0, −1, corresponding to Positive, Neutral and Negative sentiment.

The data processing module (128) constructs a True NPS framework in the form of a 3×3 Rating versus Sentiment matrix mapping the NPS Ratings and/or NPS Segments with the Response Sentiment, based on the ratings and sentiment analysis for each NPS survey response received.

The NPS rating given by a respondent is often reflective of one's individual standards (for example, a rating of 7 for one customer could be a 9 or a 6 for another customer) and hence may not represent the “True Sentiment” of the respondent towards the company or brand being surveyed. On the other hand, the comments that the respondent makes in their free-text response may be considered as being truly representative of how the customer feels about the company or brand now in the immediate present.

The new construct True NPS proposed by the present invention provides a better insight into the actual customer responses and is tailored to get an insight into several useful business metrics and KPIs (Key Performance Indicators).

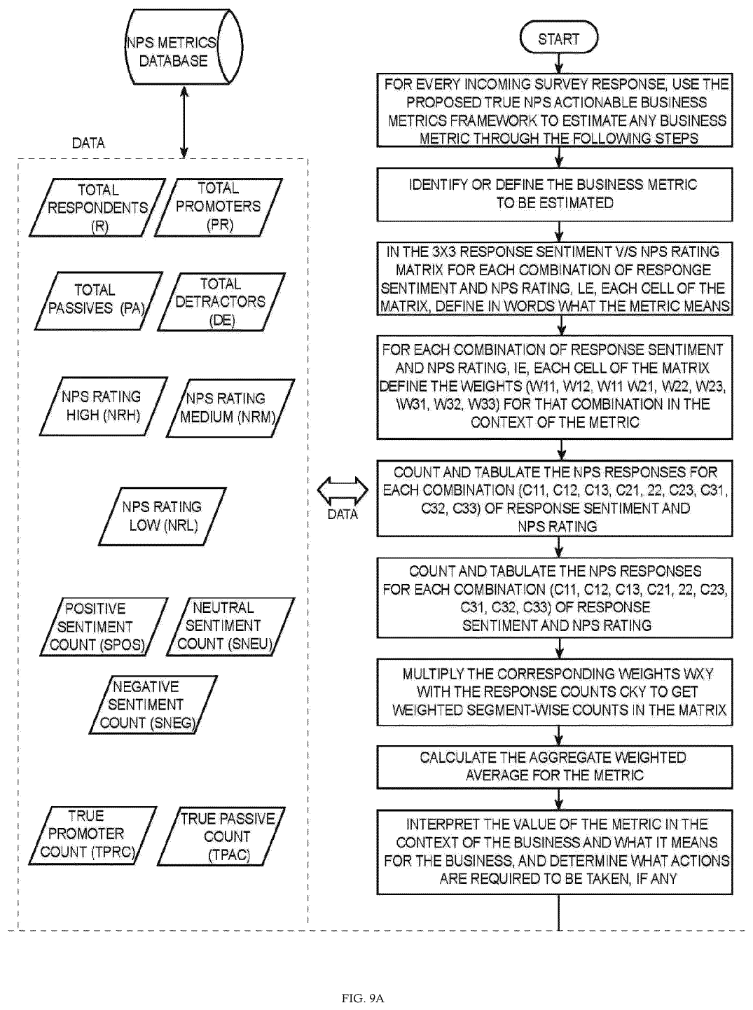

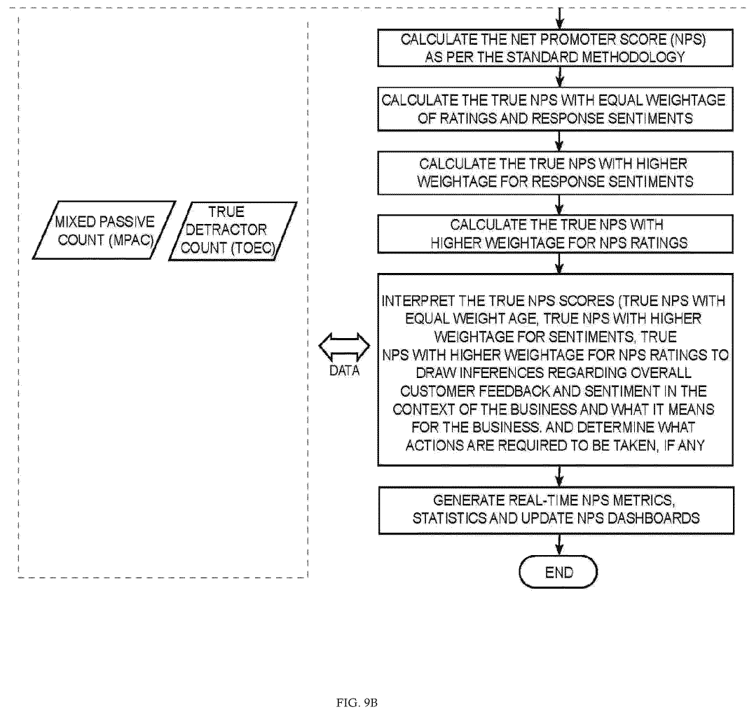

Further, the present invention also includes the computer-implemented method comprise steps of receiving a response to a net promoter score survey from a survey respondent, calculating a respondent type of promoter, passive or detractor based on the rating provided by the respondent, classifying the NPS rating into high, medium and low values, analyzing the sentiment of the free-text response given by the respondent to determine positive, negative or neutral sentiment as depicted in FIG. 2A and FIG. 2B, and further identifying or defining a metric which is to be estimated and generating a metric accordingly for each combination of a response sentiment and a net promoter score rating, defining a weight value for said combination of a response sentiment and a net promoter score rating, counting and tabulating the response to the net promoter score survey for said combination of a response sentiment and a net promoter score rating, multiplying said weight value with the response count for obtaining a weighted segment-wise count, calculating an aggregate weighted average for the said metric, interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score as depicted in FIG. 9A and FIG. 9B.

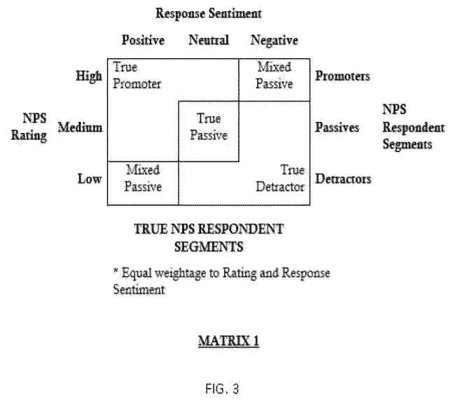

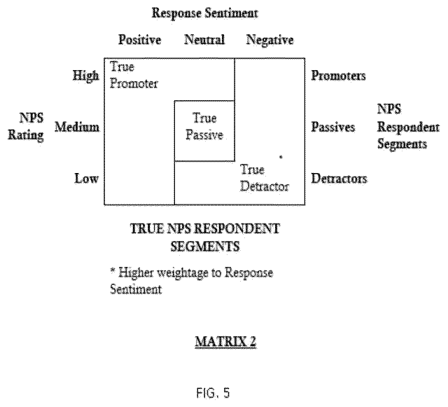

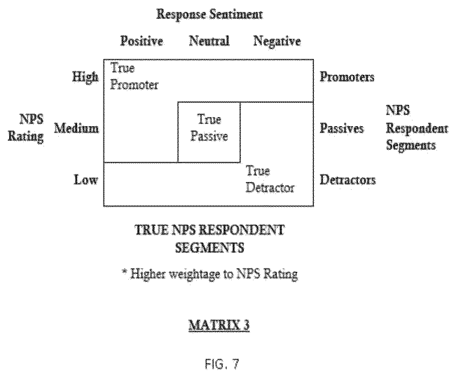

FIG. 3, FIG. 5, and FIG. 7 are schematic views of the matrix used in accordance with the present invention for mapping the response sentiment to the net promoter score rating (or to the net promoter score respondent segments) to determine the true net promoter score respondent segments (true promoters, true passives, mixed passives, and true detractors).

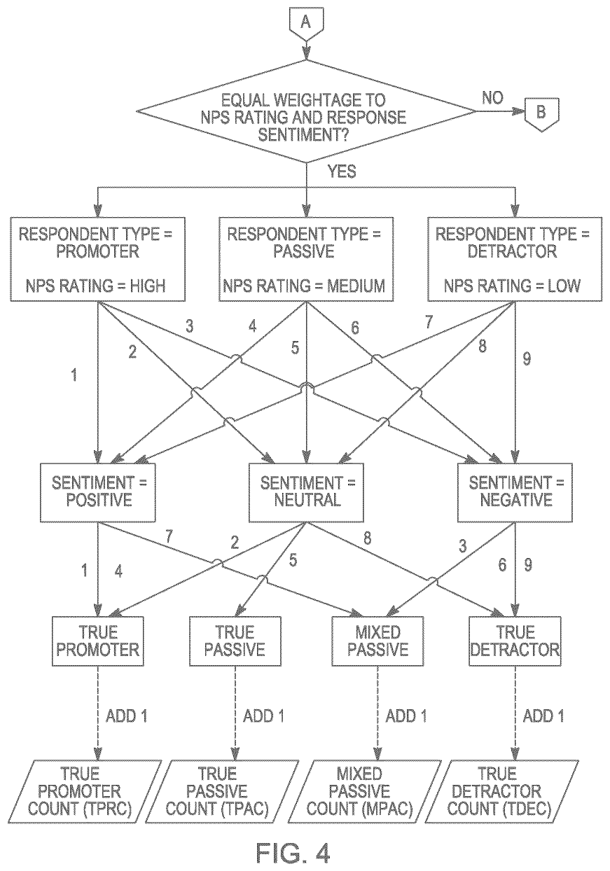

In FIG. 3 equal weightage is given to Rating and Response Sentiment. FIG. 4 is a flow diagram of determining true NPS respondent segments and counts for true promoters, true passives, mixed passives and true detractors, with equal weightage given to Rating and Response Sentiment in accordance with the present invention.

True Promoters are respondents who have given (a) a High NPS Rating AND a free-text response that has a positive or neutral sentiment (b) a Medium NPS Rating AND a free-text response that has a positive sentiment.

True Detractors are respondents who have given (a) a Low NPS Rating AND a free-text response that has a negative or neutral sentiment (b) a Medium NPS Rating AND a free-text response that has a negative sentiment.

True Passives are respondents who have given a Medium NPS Rating AND a free-text response that has a neutral sentiment.

Mixed Passives are respondents who have given (a) a Low NPS Rating AND a free-text response that has a positive sentiment (b) a High NPS Rating AND a free-text response that has a negative sentiment.

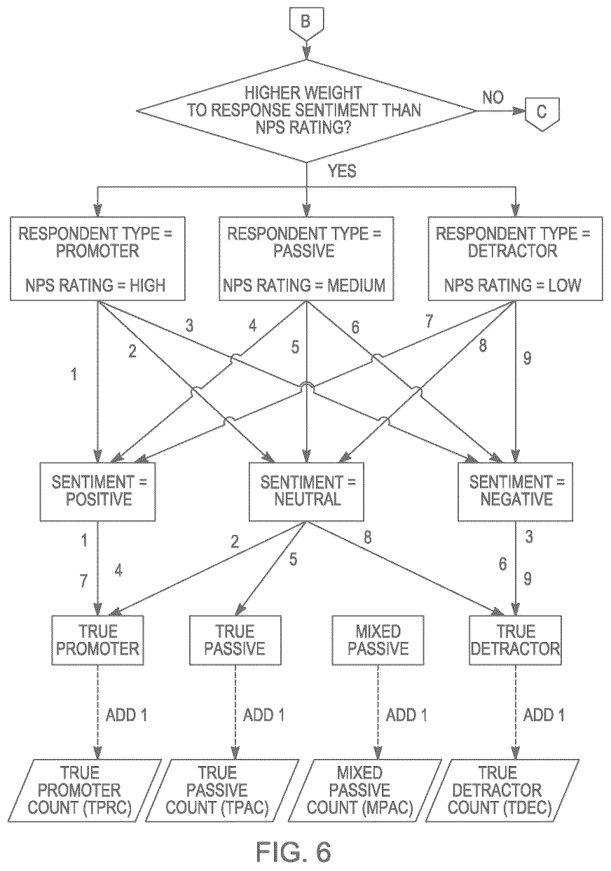

Further the matrix shown in FIG. 5 shows True NPS Respondent Segments assuming higher weightage to the Response Sentiment as compared to the Rating. The corresponding flow diagram depicted in FIG. 6 determines the true NPS respondent segments and counts for true promoters, true passives, mixed passives, and true detractors, with higher weightage given to the Response Sentiment as compared to the Rating in accordance with the present invention.

True Promoters are respondents who have given (a) a free-text response that has a positive sentiment (b) a High NPS Rating AND a free-text response that has a neutral sentiment.

True Detractors are respondents who have given (a) a free-text response that has a negative sentiment (b) a Low NPS Rating AND a free-text response that has a neutral sentiment.

True Passives are respondents who have given a Medium NPS Rating AND a free-text response that has a neutral sentiment.

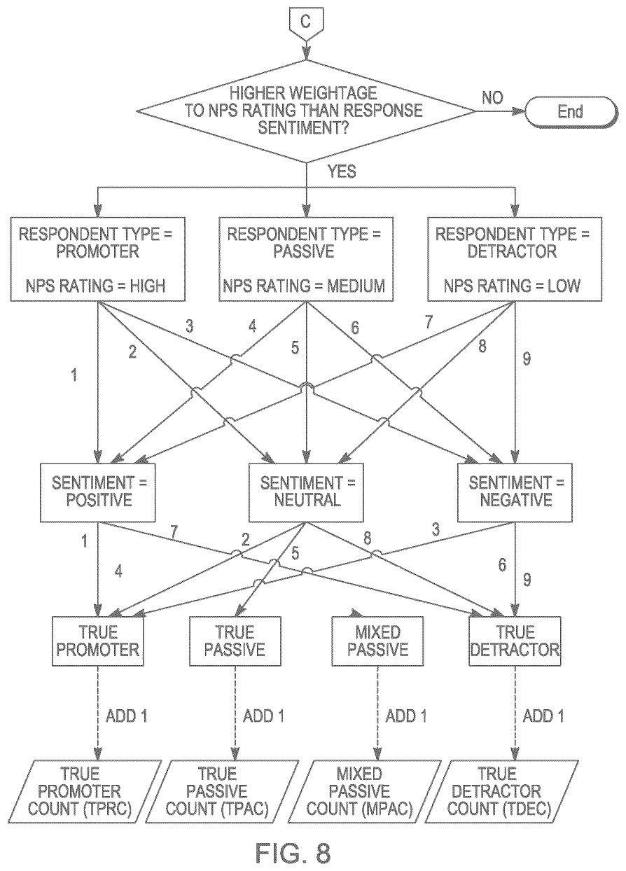

FIG. 7 depicts a matrix with True NPS Respondent Segments assuming higher weightage is given to Rating as compared to the Response Sentiment. FIG. 8 depicts the corresponding flow diagram to determine the true NPS respondent segments and counts for true promoters, true passives, mixed passives, and true detractors, with higher weightage given to the NPS Rating as compared to the Response Sentiment in accordance with the present invention.

True Promoters are respondents who have given (a) a High NPS Rating (b) a Medium NPS Rating AND a free-text response that has a positive sentiment.

True Detractors are respondents who have given (a) a Low NPS Rating (b) a Medium NPS Rating AND a free-text response that has a negative sentiment.

True Passives are respondents who have given a Medium NPS Rating AND a free-text response that has a neutral sentiment.

Through the true NPS framework, the present invention combines the NPS ratings with the “true voice of the customer” captured through the response sentiment and thus provides an optimal way for organizations to look at customers.

Further, the present invention provides a method using the true NPS framework to analyze the customer feedback captured through NPS surveys to measure and predict actionable business metrics and KPIs such as brand commitment and loyalty, customer churn and the effect on customer acquisition. The present invention terms this method as True NPS Actionable Business Metrics Framework. The method can also be named in any other way.

FIG. 9A and FIG. 9B is an overall flow diagram of method for estimating influencing metrics and impact of customer sentiment on net promoter score.

According to an exemplary embodiment, the present invention works by identifying or defining the business metric to be estimated.

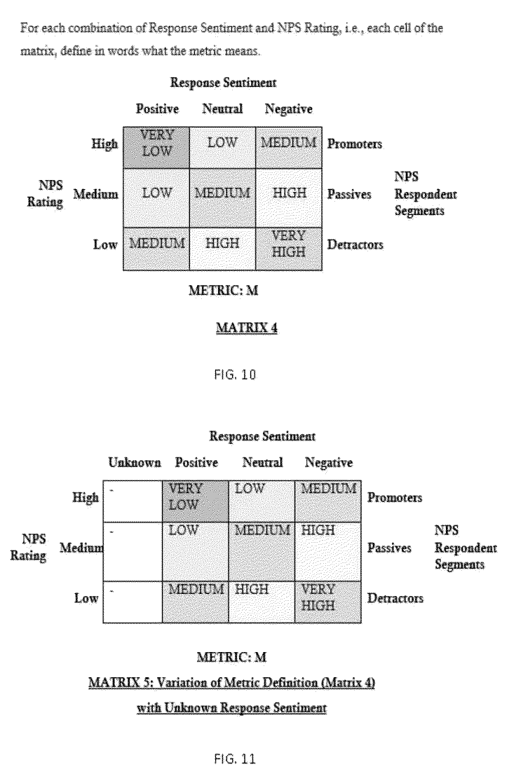

Next, the Response Sentiment vs NPS Rating matrix in FIG. 10 is used to define in words what the metric means, for each combination of Response Sentiment and NPS Rating, i.e., each cell of the matrix. For different metrics, the word descriptions may be different based on the context of the metric with respect to Response Sentiment and NPS Rating. The cells of the matrix may be color coded for visual clarity when reading the matrix for the given business metric as depicted in FIG. 10.

In the existing standard NPS methodology, it is mandatory for the respondent to provide a rating on a scale of 0 to 10, but the free-text response question “Please tell us the reason for your rating” is not mandatory. Thus, if a respondent provides a rating but skips the free-text response question, it may not be possible to determine the sentiment of the response text. One possible approach is to make the free-text response in the standard NPS survey mandatory, so that the respondent must submit a response and cannot skip it. Alternatively, if the free-text response is not mandatory, then the Response Sentiments (Positive, Negative, Neutral) proposed in the present invention can include a fourth segment Unknown. If the respondent skips the free-text response in an NPS survey, it can be classified as an Unknown sentiment. The Response Sentiment vs NPS Rating matrix including an Unknown sentiment is depicted in FIG. 11.

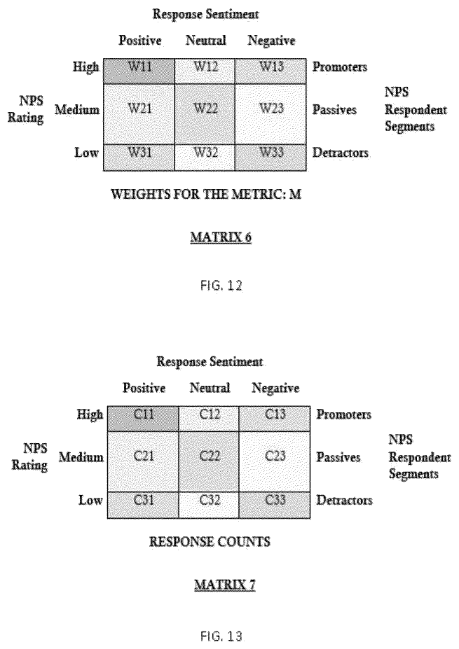

Next, for each combination of response sentiment and NPS Rating, i.e., each cell of the matrix, the weights (W11, W12, W13, W21, W22, W23, W31, W32, and W33) are defined for that combination in the context of the metric. The weights for the metric are depicted in the matrix in FIG. 12. The weights may be defined based on some industry or sector benchmarks or averages, or the weights may be defined or assigned by the business based on their business drivers or business needs.

Further, the present invention includes a step of counting and tabulating the NPS responses for each combination (C11, C12, C13, C21, C22, C23, C31, C32, C33) of response sentiment and NPS Rating, as depicted in the matrix in FIG. 13. For each NPS survey response, the NPS rating is available in the response. The data processing module analyzes the response sentiment. Based on this, the NPS Rating and the Response Sentiment are known for each survey response, and the totals are tabulated as depicted in FIG. 13. Each survey response is related to one unique respondent, so the total number of respondents can be calculated.

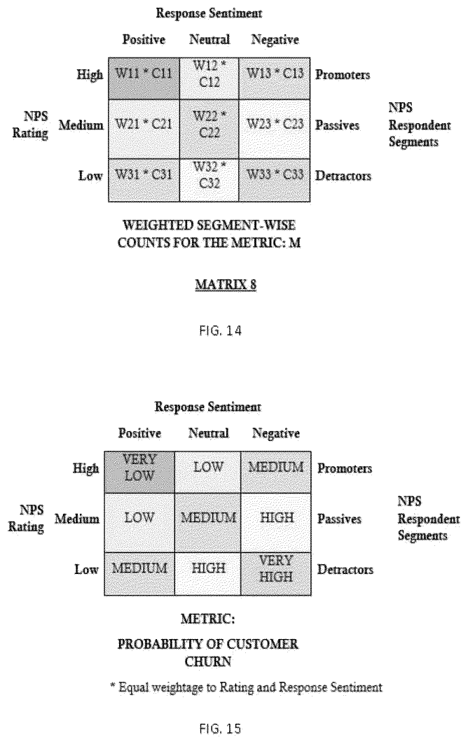

Next, the corresponding weights in FIG. 12 are multiplied with the response counts in FIG. 13 to get the weighted segment-wise count of responses as depicted in FIG. 14.

Further, the system is configured to calculate the aggregate weighted average for the metric as per the following equation:

Weighted Average for the metric=Aggregate Weighted Total/Total Counts=(W11*C11+W12*C12+W13*C13+W21*C21+W22*C22+W23*C23+W31*C31+W32*C32+W33*C33)/(C11+C12+C13+C21+C22+C23+C31+C32+C33) [Equation 1]

Once the weighted average for the metric is determined by the system in the previous step, the business stakeholders can interpret the value of the metric in the context of the business and what it means for the business, and can determine the actions that are required to be taken, if any.

The exemplary embodiment and method for True NPS Actionable Business Metrics Framework defined above is illustrated using an example outlined below.

While the example illustration assumes an equal weightage for Ratings and Response Sentiments, as per FIG. 3 and FIG. 4, similar illustrations can be easily constructed for the same business metric assuming higher weightage to Response Sentiments as per FIG. 5 and FIG. 6, or assuming higher weightage to Rating as per FIG. 7 and FIG. 8.

In this example illustration, a business metric “Probability of Customer Churn” is identified and the True NPS Matrix in FIG. 3 is used to map the probability of customer churn for a sample of NPS survey responses.

In the True NPS Matrix in FIG. 3, Response Sentiment (Positive, Neutral, Negative) is mapped on the X-Axis, whereas NPS Rating (High, Medium, Low) and NPS Respondent Segments (Promoters, Passives, Detractors) are mapped on the Y-Axis.

Further, the NPS Ratings and NPS Respondent Segments are equivalent, since a respondent is classified into one of the NPS Respondent Segments based on the NPS Ratings given by the respondent in their NPS survey response. Hence both are mapped on the Y-Axis in an equivalent way.

Next, for each combination of Response Sentiment and NPS Rating, i.e., each cell of the matrix, what the combination means in the context of the metric is defined in words. This is illustrated in FIG. 15 for the metric “Probability of Customer Churn”.

The cells of the matrix may be color coded for visual clarity when reading the matrix for the given business metric “Probability of Customer Churn” as depicted in FIG. 15.

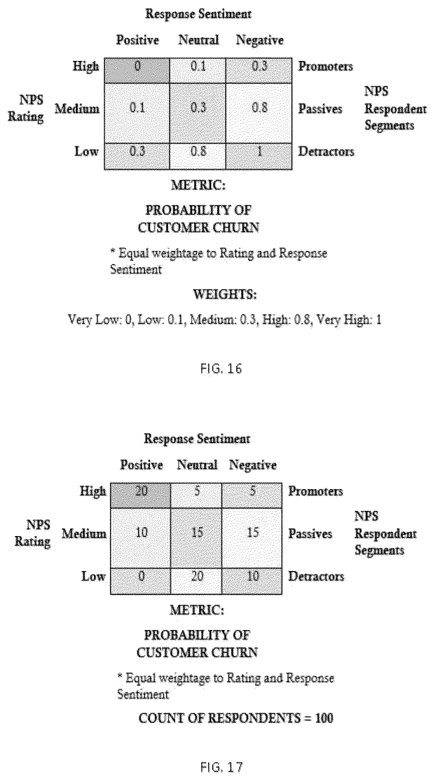

Next, for each combination of Response Sentiment and NPS Rating, i.e., each cell of the matrix, define the weights for that combination in the context of the metric (in this case, Probability of Customer Churn) as depicted in FIG. 16.

4) Next, the data processing module is configured to count and tabulate the NPS responses for each combination of Response Sentiment and NPS Rating.

In the example matrix depicted in FIG. 17, the total count of respondents is 100.

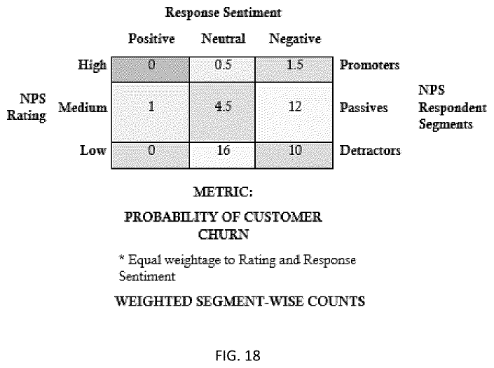

Next, the corresponding weights from matrix depicted in FIG. 16 and the response counts from matrix depicted in FIG. 17 are multiplied to get weighted segment-wise counts in matrix depicted in FIG. 18.

Based on the weighted segment-wise counts in matrix in FIG. 18, the data processing module calculates the aggregate weighted average for the metric, which gives the value of the metric based on the NPS Survey responses.

In this example illustration:

The total of all the cells of matrix in FIG. 18 is 45.5.

The total number of respondents (from the matrix in FIG. 17) is 100.

Hence, the Probability of Customer Churn=45.5/100=0.455=45.5%

Thus, from the NPS survey results, by analyzing the combination of the NPS Rating and Response Sentiments using the proposed True NPS Actionable Business Metrics Framework, the proposed method can determine the value of a given business metric. Thus, proposed “True NPS Actionable Business Metrics Framework” enables the results from a standard NPS survey to be converted into actionable business insights, which is not possible from just the standard net promoter score.

In this example, the value of the metric Probability of Customer Churn is determined to be 0.455, which is an actionable insight. Based on this, the business can now determine what actions are required by the business to, say, reduce the probability of customer churn to 0.10.

In another example illustration, the exemplary embodiment and method for determining True NPS and True NPS Respondent Segments as defined earlier in the present invention is illustrated using an example outlined below.

### Standard NPS Score:

Based on the respondent counts in the matrix in FIG. 17, if the NPS score is calculated as per the standard NPS methodology:
Promoters=20+5+5=30
Detractors=0+20+10=30
Passives=10+15+15=40
NPS Score (as per standard NPS methodology)=% Promoters-% Detractors
=30−30=0

### True NPS Respondent Segments:

The data of segment-wise respondent counts from matrix in FIG. 17 can be used to calculate the True NPS Respondent Segments and the corresponding True NPS scores.

As per Matrix 1 in FIG. 3 (assuming equal weightage of ratings and response sentiments):
True Promoters=20+5+10=35
True Detractors=20+10+15=45
True Passives=15
Mixed Passives=0+5=5
True NPS Score (equal weightage)=% Promoters−% Detractors=35−45=−10

As per Matrix 2 in FIG. 5 (assuming higher weightage for response sentiments):

$$True Promoters = 20 + 10 + 0 + 5 = 35$$

$$True Detractors = 5 + 15 + 10 + 20 = 50$$

$$True Passives = 15$$

$$True NPS Score ( higher weightage for sentiment ) = 35 - 50 = - 15$$

As per Matrix 3 in FIG. 7 (assuming higher weightage for ratings):

$$True Promoters = 20 + 5 + 5 + 10 = 40$$

$$True Detractors = 0 + 20 + 10 + 15 = 45$$

$$True Passives = 15$$

$$True NPS Score ( higher weightage for ratings ) = 40 - 45 = - 5$$

From the above examples, it is observed that using the standard NPS methodology, the NPS score would be zero (0).

However, the True NPS score would be different based on the weightages assigned to the NPS Rating and Response Sentiments, respectively.
True NPS Score (equal weightage)=−10
True NPS Score (higher weightage for sentiment)=−15
True NPS Score (higher weightage for ratings)=−5
Thus, from the True NPS score, it is inferred that the overall customer feedback and sentiment is negative. This insight is not possible using the standard methodology NPS score of zero.

Therefore, the present invention enables the results from a standard NPS survey to be converted into actionable business insights, which is not possible from just the standard NPS Score. Further the present invention utilizes the sentiment derived from respondent responses in a standard NPS survey to create three unique segments. These segments hold the potential to make valuable inferences and estimations on crucial business metrics such as the likelihood of churn, customer acquisition, and brand commitment/loyalty. Secondly, the present invention introduces an approach by combining NPS ratings with the relevant sentiment obtained from respondent responses to recalibrate the NPS Score into a True NPS Score. Additionally, the invention proposes the concept of True NPS Respondent Segments, including True Promoters, True Passives, and True Detractors, along with a method to calculate these segments based on three scenarios: equal weightage for ratings and sentiment, higher weightage for sentiment, and higher weightage for ratings. This segmentation methodology provides a fresh perspective and enhances the accuracy and effectiveness of NPS analysis. Lastly, the present invention provides a system which includes a framework, termed the True NPS Actionable Business Metrics Framework. This framework outlines a systematic and step-wise process for estimating various business metrics, thereby offering a unique and comprehensive approach to assess and improve business performance.

In addition to this, the proposed True NPS Actionable Business Metrics Framework provides a True NPS Score and a True NPS Respondents Segment Matrix (which maps the NPS Rating and NPS Respondent Segments to the Response Sentiment as depicted in FIG. 3, FIG. 5 and FIG. 7) which is presented on an output module. The output module includes a graphical user interface which presents the actionable True NPS Score and a True NPS Respondents Segment Matrix in an online visual dashboard format and a downloadable report format for a clear visualization.

The present invention also provides a non-transitory computer-readable storage medium for storing one or more instructions for estimating influencing metrics and impact of customer sentiment on net promoter score. The storage medium comprising an executable code which when executed by one or more units of a system causes a processor to receive a response to a net promoter score survey from a survey respondent. The processor is further configured to calculate a respondent type of promoter, passive or detractor based on the rating provided by the respondent, classifying the net promoter score rating into high, medium and low values, analyzing the sentiment of the free-text response given by the respondent to determine positive, negative or neutral sentiment. The processor is further configured to identify or defining a metric which is to be estimated and generating a metric accordingly for each combination of a response sentiment and a net promoter score rating. The processor is further configured to define a weight value for said combination of a response sentiment and a net promoter score rating. The processor is further configured to count and tabulating the response to the net promoter score survey for said combination of a response sentiment and a net promoter score rating. The processor is further configured to multiply said weight value with the response count for obtaining a weighted segment-wise count in a metric. The processor is further configured to calculate an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

The present invention also provides a user device for estimating influencing metrics and impact of customer sentiment on net promoter score. The user device comprises a memory, a processor connected with the memory. The processor is configured to estimate influencing metrics and impact of customer sentiment on net promoter score equity via a system and the influencing metrics and impact of customer sentiment on net promoter score equity is estimated by receiving a response to a net promoter score survey from a survey respondent. The influencing metrics and impact of customer sentiment on net promoter score equity is further estimated by calculating a respondent type of promoter, passive or detractor based on the rating provided by the respondent, classifying the net promoter score rating into high, medium and low values, analyzing the sentiment of the free-text response given by the respondent to determine positive, negative or neutral sentiment and identifying or defining a metric which is to be estimated and generating a metric accordingly for each combination of a response sentiment and a net promoter score rating. The influencing metrics and impact of customer sentiment on net promoter score equity is further estimated by defining a weight value for said combination of a response sentiment and a net promoter score rating and counting and tabulating the response to the net promoter score survey for said combination of a response sentiment and a net promoter score rating. The influencing metrics and impact of customer sentiment on net promoter score equity is further estimated by multiplying said weight value with the response count for obtaining a weighted segment-wise count in a metric and calculating an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

The present invention may be a system, a method, and/or a computer program product at any possible technical detail level of integration. The computer program product may include a computer-readable storage medium (or media) having the computer-readable program instructions thereon for causing the one or more hardware processor to carry out aspects of the present invention.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include script, batch, or other executable files. The modules may be stored on a machine-readable or computer readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removable or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a module for calling sub-modules may be decomposed so that each sub-module performs its function and passes control directly to another sub-module.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A system (100) for estimating influencing metrics and impact of customer sentiment on net promoter score, comprising of:
one or more hardware processors (105); and
a memory (125) coupled to the one or more hardware processors (105), wherein the memory (125) comprise a plurality of modules (126) in the form of programmable instructions executable by the one or more hardware processors (105);
wherein:
said plurality of modules (126) comprise of a data acquisition module (127) for receiving a response to a net promoter score survey from a survey respondent, a data processing module (128) for estimating one or more influencing metrics and impact of customer sentiment on said net promoter score;
said data processing module (128) is configured to calculate a respondent type of promoter, passive or detractor based on the rating provided by the respondent, classify the net promoter score (NPS) rating into high, medium and low values, and analyze the sentiment of the free-text response given by the respondent to determine positive, negative or neutral sentiment, further the data processing module (128) is configured to:
identify or define a metric which is to be estimated and generating a metric accordingly for each combination of the response sentiment and net promoter score rating;
define a weight value for said combination of the response sentiment and the net promoter score rating;
count and tabulate the response to the net promoter score survey for said combination of a response sentiment and a net promoter score rating;
multiply said weight value with the response count for obtaining a weighted segment-wise count; and
calculate an aggregate weighted average for the metric and interpret a value of said metric in a business context, calculate a true net promoter score with equal weightage to response sentiment and net promoter score rating, calculate a true net promoter score with higher weightage to response sentiment than net promoter score rating, calculate a true net promoter score with higher weightage to net promoter score rating than response sentiment, and interpret the true net promoter scores in a business context for estimating one or more influencing metrics and impact of customer sentiment on said net promoter score.

2. The system (100) for estimating influencing metrics and impact of customer sentiment on net promoter score as claimed in claim 1, wherein the data acquisition module (127) includes scanner, camera, keyboard, microphone, mouse and touchpad.

3. The system (100) for estimating influencing metrics and impact of customer sentiment on net promoter score as claimed in claim 1, wherein the data processing module (128) refers to a central processing unit and is preferably a microprocessor.

4. The system (100) for estimating influencing metrics and impact of customer sentiment on net promoter score as claimed in claim 1, wherein the data acquisition module (127) transfers the response from the respondent to the data processing module (128).

5. The system (100) for estimating influencing metrics and impact of customer sentiment on net promoter score as claimed in claim 1, wherein the system (100) further comprise of an input means (112) for receiving an input data and a data storage unit (130) for storing incoming input data or having a pre-stored data.

6. The system (100) for estimating influencing metrics and impact of customer sentiment on net promoter score as claimed in claim 1, wherein the net promoter score survey comprise of a set of questions for the respondent.

7. The system (100) for estimating influencing metrics and impact of customer sentiment on net promoter score as claimed in claim 1, wherein the response sentiment includes but not limited to positive, neutral and negative.

8. The system (100) for estimating influencing metrics and impact of customer sentiment on net promoter score as claimed in claim 1, wherein the net promoter score rating is selected but not limited from high, medium and low.

9. The system (100) for estimating influencing metrics and impact of customer sentiment on net promoter score as claimed in claim 1, wherein the matrix mapping the net promoter score ratings and/or net promoter score segments with the response sentiment is preferably a 3×3 matrix.

10. The system (100) for estimating influencing metrics and impact of customer sentiment on net promoter score as claimed in claim 1, wherein the equal weightage for a net promoter score rating and response sentiment includes the true promoters that are respondents who have given a high net promoter score rating and a free-text response that has a positive or neutral sentiment, or, a medium net promoter score rating and free-text response that has a positive sentiment.

11. The system (100) for estimating influencing metrics and impact of customer sentiment on net promoter score as claimed in claim 1, wherein the equal weightage for a net promoter score rating and response sentiment includes the true detractors that are respondents who have given a low net promoter score rating and a free-text response that has a negative or neutral sentiment, or, a medium net promoter score rating and a free-text response that has a negative sentiment.

12. The system (100) for estimating influencing metrics and impact of customer sentiment on net promoter score as claimed in claim 1, wherein the equal weightage for a net promoter score rating and response sentiment includes the true passives that are respondents who have given a medium net promoter score rating and a free-text response that has a neutral sentiment.

13. The system (100) for estimating influencing metrics and impact of customer sentiment on net promoter score as claimed in claim 1, wherein the equal weightage for a net promoter score rating and response sentiment includes the mixed passives that are respondents who have given a low net promoter score rating and a free-text response that has a positive sentiment, or, a high net promoter score rating and a free-text response that has a negative sentiment.

14. The system (100) for estimating influencing metrics and impact of customer sentiment on net promoter score as claimed in claim 1, wherein the higher weightage for a response sentiment includes the true promoters that are respondents who have given a free text response that has a positive sentiment, or, a high net promoter score rating and a free text response that has a neutral sentiment.

15. The system (100) for estimating influencing metrics and impact of customer sentiment on net promoter score as claimed in claim 1, wherein the higher weightage for a response sentiment includes the true detractors that are respondents who have given a free text response that has a negative sentiment, or, a low net promoter score rating and a free text response that has a neutral sentiment.

16. The system (100) for estimating influencing metrics and impact of customer sentiment on net promoter score as claimed in claim 1, wherein the higher weightage for a response sentiment includes the true passives that are respondents who have given a medium net promoter score rating and a free text response that has a neutral sentiment.

17. The system (100) for estimating influencing metrics and impact of customer sentiment on net promoter score as claimed in claim 1, wherein the higher weightage for the net promoter score rating includes the true promoters that are respondents who have given a high net promoter score rating, or, a medium net promoter score rating and a free text response that has a positive sentiment.

18. The system (100) for estimating influencing metrics and impact of customer sentiment on net promoter score as claimed in claim 1, wherein the higher weightage for the net promoter score rating includes the true detractors that are respondents who have given a low net promoter score rating, or, a medium net promoter score rating and a free text response that has a negative sentiment.

19. The system (100) for estimating influencing metrics and impact of customer sentiment on net promoter score as claimed in claim 1, wherein the higher weightage for the net promoter score rating includes the true passives that are respondents who have given a medium net promoter score rating and a free text response that has a neutral sentiment.

20. The system (100) for estimating influencing metrics and impact of customer sentiment on net promoter score as claimed in claim 1, wherein the true net promoter scores are presented on an output module.

21. The system (100) for estimating influencing metrics and impact of customer sentiment on net promoter score as claimed in claim 20, wherein the output module includes a graphical user interface which presents the net promoter score ratings versus response sentiment matrixes for different business metrics, true net promoter scores with equal weightage for a net promoter score rating and response sentiment, true net promoter scores with higher weightage for a net promoter score rating and true net promoter scores with higher weightage for response sentiment in a visual dashboard format and a downloadable report format for a clear visualization and interpretation.

22. A method for estimating influencing metrics and impact of customer sentiment on net promoter score comprising steps of:
a) receiving a response to a net promoter score survey from a survey respondent;
b) calculating a respondent type of promoter, passive or detractor based on the rating provided by the respondent, classifying the net promoter score rating into high, medium and low values, analyzing the sentiment of the free-text response given by the respondent to determine positive, negative or neutral sentiment;
c) identifying or defining a metric which is to be estimated and generating a metric accordingly for each combination of a response sentiment and a net promoter score rating;
d) defining a weight value for said combination of a response sentiment and a net promoter score rating;
e) counting and tabulating the response to the net promoter score survey for said combination of a response sentiment and a net promoter score rating;
f) multiplying said weight value with the response count for obtaining a weighted segment-wise count in a metric; and
g) calculating an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

23. The method for estimating influencing metrics and impact of customer sentiment on net promoter score as claimed in claim 22, wherein the net promoter score survey comprise of a set of questions for the respondent.

24. The method for estimating influencing metrics and impact of customer sentiment on net promoter score as claimed in claim 22, wherein the response sentiment includes but not limited to positive, neutral and negative.

25. The method for estimating influencing metrics and impact of customer sentiment on net promoter score as claimed in claim 22, wherein the net promoter score rating is selected but not limited from high, medium and low.

26. The method for estimating influencing metrics and impact of customer sentiment on net promoter score as claimed in claim 22, wherein the matrix mapping the net promoter score ratings and/or net promoter score segments with the response sentiment is preferably a 3×3 matrix.

27. The method for estimating influencing metrics and impact of customer sentiment on net promoter score as claimed in claim 22, wherein the equal weightage for a net promoter score rating and response sentiment includes the true promoters that are respondents who have given a high net promoter score rating and a free-text response that has a positive or neutral sentiment, or, a medium net promoter score rating and free-text response that has a positive sentiment.

28. The method for estimating influencing metrics and impact of customer sentiment on net promoter score as claimed in claim 22, wherein the equal weightage for a net promoter score rating and response sentiment includes the true detractors that are respondents who have given a low net promoter score rating and a free-text response that has a negative or neutral sentiment, or, a medium net promoter score rating and a free-text response that has a negative sentiment.

29. The method for estimating influencing metrics and impact of customer sentiment on net promoter score as claimed in claim 22, wherein the equal weightage for a net promoter score rating and response sentiment includes the true passives that are respondents who have given a medium net promoter score rating and a free-text response that has a neutral sentiment.

30. The method for estimating influencing metrics and impact of customer sentiment on net promoter score as claimed in claim 22, wherein the equal weightage for a net promoter score rating and response sentiment includes the mixed passives that are respondents who have given a low net promoter score rating and a free-text response that has a positive sentiment, or, a high net promoter score rating and a free-text response that has a negative sentiment.

31. The method for estimating influencing metrics and impact of customer sentiment on net promoter score as claimed in claim 22, wherein the higher weightage for a response sentiment includes the true promoters that are respondents who have given a free text response that has a positive sentiment, or, a high net promoter score rating and a free text response that has a neutral sentiment.

32. The method for estimating influencing metrics and impact of customer sentiment on net promoter score as claimed in claim 22, wherein the higher weightage for a response sentiment includes the true detractors that are respondents who have given a free text response that has a negative sentiment, or, a low net promoter score rating and a free text response that has a neutral sentiment.

33. The method for estimating influencing metrics and impact of customer sentiment on net promoter score as claimed in claim 22, wherein the higher weightage for a response sentiment includes the true passives that are respondents who have given a medium net promoter score rating and a free text response that has a neutral sentiment.

34. The method for estimating influencing metrics and impact of customer sentiment on net promoter score as claimed in claim 22, wherein the higher weightage for the net promoter score rating includes the true promoters that are respondents who have given a high net promoter score rating, or, a medium net promoter score rating and a free text response that has a positive sentiment.

35. The method for estimating influencing metrics and impact of customer sentiment on net promoter score as claimed in claim 22, wherein the higher weightage for the net promoter score rating includes the true detractors that are respondents who have given a low net promoter score rating, or, a medium net promoter score rating and a free text response that has a negative sentiment.

36. The method for estimating influencing metrics and impact of customer sentiment on net promoter score as claimed in claim 22, wherein the higher weightage for the net promoter score rating includes the true passives that are respondents who have given a medium net promoter score rating and a free text response that has a neutral sentiment.

37. The method for estimating influencing metrics and impact of customer sentiment on net promoter score as claimed in claim 22, wherein the true net promoter scores are displayed through a graphical user interface which presents the net promoter score ratings versus response sentiment matrixes for different business metrics, true net promoter scores with equal weightage for a net promoter score rating and response sentiment, true net promoter scores with higher weightage for a net promoter score rating and true net promoter scores with higher weightage for response sentiment in a visual dashboard format and a downloadable report format for a clear visualization and interpretation.

38. A non-transitory computer-readable storage medium for storing one or more instructions for estimating influencing metrics and impact of customer sentiment on net promoter score, wherein the storage medium comprising an executable code which when executed by one or more units of a system causes a processor to:
receive a response to a net promoter score survey from a survey respondent;
calculate a respondent type of promoter, passive or detractor based on the rating provided by the respondent, classifying the net promoter score rating into high, medium and low values, analyzing the sentiment of the free-text response given by the respondent to determine positive, negative or neutral sentiment;
identify or defining a metric which is to be estimated and generating a metric accordingly for each combination of a response sentiment and a net promoter score rating;
define a weight value for said combination of a response sentiment and a net promoter score rating;
count and tabulating the response to the net promoter score survey for said combination of a response sentiment and a net promoter score rating;
multiply said weight value with the response count for obtaining a weighted segment-wise count in a metric; and
calculate an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.

39. A user device for estimating influencing metrics and impact of customer sentiment on net promoter score, comprising:
a memory;
a processor connected with the memory, wherein the processor is configured to estimate influencing metrics and impact of customer sentiment on net promoter score equity via a system and the influencing metrics and impact of customer sentiment on net promoter score equity is estimated by:
receiving a response to a net promoter score survey from a survey respondent;
calculating a respondent type of promoter, passive or detractor based on the rating provided by the respondent, classifying the net promoter score rating into high, medium and low values, analyzing the sentiment of the free-text response given by the respondent to determine positive, negative or neutral sentiment;
identifying or defining a metric which is to be estimated and generating a metric accordingly for each combination of a response sentiment and a net promoter score rating;
defining a weight value for said combination of a response sentiment and a net promoter score rating;
counting and tabulating the response to the net promoter score survey for said combination of a response sentiment and a net promoter score rating;
multiplying said weight value with the response count for obtaining a weighted segment-wise count in a metric; and
calculating an aggregate weighted average for the metric and interpreting a value of said metric in a business context, calculating a true net promoter score with equal weightage to response sentiment and net promoter score rating, calculating a true net promoter score with higher weightage to response sentiment than net promoter score rating, calculating a true net promoter score with higher weightage to net promoter score rating than response sentiment, and interpreting the true net promoter scores in a business context for estimating one or more influencing metrics and impact of customer sentiment on said net promoter score.
